(19) United States
(12) Patent Application Publication
(10) Pub. No.: US 2021/0107265 A1
(43) Pub. Date: Apr. 15, 2021

(54) IMPACT ABSORPTION SHEET AND DOUBLE-SIDED PRESSURE-SENSITIVE ADHESIVE SHEET

(71) Applicant: SEKISUI CHEMICAL CO., LTD., Osaka (JP)

(72) Inventors: Toshiaki HIRATA, Shiga (JP); Yuki IWAI, Osaka (JP); Noriyuki UCHIDA, Shiga (JP)

(73) Assignee: SEKISUI CHEMICAL CO., LTD., Osaka (JP)

(21) Appl. No.: 16/608,461

(22) PCT Filed: Apr. 27, 2018
(86) PCT No.: PCT/JP2018/017272

§ 371 Date: Oct. 25, 2019

(30) Foreign Application Priority Data
May 2, 2017 (JP) 2017-091753

(51) Int. Cl. B32B 27/32; C09J 7/24; B32B 27/08

(52) U.S. Cl. CPC B32B 27/32; C09J 7/241; B32B 27/08; C09J 2423/006; B32B 2457/00; B32B 2307/558; B32B 2307/54; B32B 2405/00; C09J 2301/124

(57) ABSTRACT

The present invention aims to provide an impact-absorbing sheet having high impact resistance and excellent resistance against sebum. The present invention also aims to provide a double-sided adhesive sheet including the impact-absorbing sheet. Provided is an impact-absorbing sheet including an impact-absorbing layer, the impact-absorbing layer having a maximum value of loss tangent tan δ of 0.7 or more at a frequency of 1.0×10³ to 1.0×10^{6.5} Hz at 23° C. and having a degree of crystallinity of 2% or higher.

### TECHNICAL FIELD

The present invention relates to an impact-absorbing sheet. The present invention also relates to a double-sided adhesive sheet including the impact-absorbing sheet.

### BACKGROUND ART

Adhesive tapes are used for assembling portable electronic devices (e.g., cellular phones and personal digital assistants) equipped with image display devices or input devices. Specifically, for example, adhesive tapes are used to bond a front plate (cover panel) for protecting a surface of a portable electronic device to a touch panel module or display panel module, or to bond a touch panel module to a display panel module. Such adhesive tapes, for example, are punched to obtain a shape such as frame shape and placed around the display screen (e.g., Patent Literatures 1 and 2).

Adhesive tapes used for portable electronic devices are required to have high adhesive force and other various properties. For example, adhesive tapes are required to have impact resistance so that they do not peel off even under impact and can protect components from a strong impact.

An exemplary method for improving the impact resistance of an adhesive tape is to use a substrate having cushioning properties such as a foam. Patent Literature 3 discloses an adhesive sheet for an electronic device including a cross-linked polyolefin resin foam sheet and a specific acrylic adhesive layer integrally laminated on one surface of the cross-linked polyolefin resin foam sheet.

With the recent increase in the size of the screen of portable electronic devices, adhesive tapes are becoming larger in size. In addition, since adhesive tapes are used in a shape such as a frame shape, the width of adhesive tapes is becoming smaller. For these reasons, even adhesive tapes with small areas are required not to peel off, and the level of impact resistance required is getting higher.

Portable electronic devices are always carried or kept at hand for frequent use. They are also operated via touch panels or the like with bare hands. The adhesive tape with a foam substrate such as that disclosed in Patent Literature 3 thus tends to deteriorate due to sebum and peel off.

### CITATION LIST

### Patent Literature

Patent Literature 1: JP 2011-081213 A
Patent Literature 2: JP 2003-337656 A
Patent Literature 3: JP 2011-168727 A

### SUMMARY OF INVENTION

### Technical problem

The present invention aims to provide an impact-absorbing sheet having high impact resistance and excellent resistance against sebum. The present invention also aims to provide a double-sided adhesive sheet including the impact-absorbing sheet.

### Solution to problem

The present invention relates to an impact-absorbing sheet including an impact-absorbing layer, the impact-absorbing layer having a maximum value of loss tangent tan δ of 0.7 or more at a frequency of 1.0×10³ to 1.0×10^{6.5} Hz at 23° C. and having a degree of crystallinity of 2% or higher.

The present invention is described in detail below.

The present inventors found out that exposing an adhesive tape including a foam as a substrate to sebum causes deposition of fat in the bubble portions of the foam. The inventors found that the exudation of the fat to the adhesive layer causes peeling of the adhesive tape. The use of a non-foam material instead of the foam as a substrate was thus considered. However, such a non-foam material may dissolve or swell when contacting sebum and lose its shape, causing peeling of the adhesive tape.

Impact-absorbing sheets including an impact-absorbing layer are suitable as a substrate of a double-sided adhesive sheet. The present inventors found out that both the impact resistance and the resistance against sebum of such an impact-absorbing sheet can be improved by adjusting the maximum value of loss tangent tan δ of the impact-absorbing layer at 23° C. at a specific frequency to a specific value or higher and adjusting the degree of crystallinity to a specific value or higher. The inventors thus completed the present invention. Even when impact of a drop or the like is applied, such an impact-absorbing layer can effectively dissipate the impact energy as heat or by deformation, thus suppressing the peeling of the double-sided adhesive sheet. In addition, since the impact-absorbing layer has high denseness, the impact-absorbing layer suppresses the entry and absorption of fat even when exposed to sebum, thus suppressing the peeling of the double-sided adhesive sheet.

The impact-absorbing sheet of the present invention includes an impact-absorbing layer.

The impact-absorbing layer has a maximum value of loss tangent tan δ of 0.7 or more at a frequency of 1.0×10³ to 1.0×10^{6.5} Hz at 23° C. and a degree of crystallinity of 2% or higher.

With the maximum value of loss tangent tan δ of 0.7 or more, the impact-absorbing layer has improved impact resistance. Thus, even when the impact-absorbing sheet of the present invention is used as a substrate of a double-sided adhesive sheet and impact of a drop or the like is applied thereto, the peeling of the double-sided adhesive sheet is suppressed because the impact energy can be effectively dissipated as heat or by deformation. The maximum value of loss tangent tan δ is 0.7 or more, preferably 0.8 or more, more preferably 0.9 or more.

The upper limit of the maximum value of loss tangent tan δ is not limited. When the impact-absorbing layer contains a large amount of a viscous component and has too high a maximum value of loss tangent tan δ, the impact-absorbing layer easily undergoes plastic deformation upon absorbing impact. The upper limit is thus preferably 3.0, more preferably 2.7.

The maximum value of loss tangent tan δ at a frequency of 1.0×10³ to 1.0×10^{6.5} Hz at 23° C. can be determined by measuring the modulus of elasticity of the impact-absorbing layer using a dynamic viscoelasticity measuring apparatus (e.g., Rheogel-E4000 available from UBM) and establishing a master curve. It is not necessarily required that a “local maximum value” of loss tangent tan δ is within the frequency range of 1.0×10³ to 1.0×10^{6.5} Hz. When the “local maximum value” is within the frequency range of 1.0×10³ to 1.0×10^{6.5} Hz, however, the impact-absorbing layer can easily stably absorb impact even in the case where impact is applied to the impact-absorbing layer at a temperature higher or lower than 23° C.

The frequency of 1.0×10³ to 1.0×10^{6.5} Hz simulates a frequency at which the impact-absorbing layer is displaced by several micrometers to several tens of micrometers when an object falls freely on the impact-absorbing layer from a height of several tens of centimeters to one meter and several tens of centimeters. In other words, the frequency of 1.0×10³ to 1.0×10^{6.5} Hz simulates the case where impact of a drop or the like is applied to a portable electronic device.

With the degree of crystallinity of 2% or higher, the impact-absorbing layer has improved resistance against sebum. Even when the impact-absorbing sheet of the present invention is used as a substrate of a double-sided adhesive sheet and exposed to sebum, the entry and absorption of fat is suppressed due to high denseness of the impact-absorbing layer. The peeling of the double-sided adhesive sheet is thus suppressed. The degree of crystallinity is 2% or higher, preferably 4% or higher, more preferably 6% or higher. The upper limit of the degree of crystallinity is not limited. The impact-absorbing layer with too high a degree of crystallinity is less likely to undergo plastic deformation upon absorbing impact. The upper limit is thus preferably 15%, more preferably 10%.

The degree of crystallinity can be measured using an X-ray diffraction device (e.g., SmartLab available from Rigaku Corp.). Specifically, the impact-absorbing layer is irradiated with X-rays. In the obtained diffraction data (diffraction profile), a scattering region derived from an amorphous portion and a scattering region derived from a crystalline portion are separated. The degree of crystallinity is calculated as the ratio of the integrated crystalline scattering intensity to the total integrated scattering intensity. The waveform separation between the amorphous portion and the crystalline portion can be performed with analysis software using a multiple peak separation program.

To adjust the maximum value of loss tangent tan δ within the above range and adjust the degree of crystallinity within the above range, the composition of the impact-absorbing layer may be adjusted within the range described later. In particular, the impact-absorbing layer preferably contains an olefin elastomer having a crystalline structure.

The “crystalline structure” in the olefin elastomer having a crystalline structure means, for example, a structure that exhibits crystallinity due to monomers linearly linked to each other in a polymer (high molecular compound). Examples of compounds having such a structure include linear polyolefins.

The olefin elastomer having a crystalline structure may be a random copolymer or a block copolymer.

Examples of the random copolymer among the olefin elastomers having a crystalline structure include linear low density polyethylene (LLDPE) and high density polyethylene (HDPE). Examples of the block copolymer include olefin crystal-ethylene-butylene-olefin crystal (CEBC) block polymers and styrene-ethylene-butylene-olefin crystal (SEBC) block polymers. These olefin elastomers having a crystalline structure may be used alone or in combination of two or more thereof. Preferred among them is CEBC block polymers because linear portions in sequence provide a denser crystalline structure.

The olefin elastomer having a crystalline structure is preferably a non-crosslinked olefin elastomer because crosslinked ones are less likely to exhibit flexibility.

The olefin elastomer having a crystalline structure may be used in combination with a different elastomer.

In this case, the olefin elastomer having a crystalline structure and the different elastomer preferably have a difference in solubility parameter (SP value) of 2 or less. When the difference in SP value is 2 or less, the olefin elastomer having a crystalline structure and the different elastomer have high compatibility. As a result, when the impact-absorbing sheet of the present invention is used as a substrate of a double-sided adhesive sheet, the double-sided adhesive sheet, even with a small area, can exhibit stable performance. The difference in SP value is more preferably 1 or less.

The solubility parameter (SP value) (unit: (cal/cm3)^{1/2}) is an index of the compatibility between resins or elastomers. For example, the SP value can be calculated by the Fedor's equation below.

SP=(EE/EV)^{1/2}

EE: Cohesive energy

EV: Molar volume [Math. 1]

In the case where the olefin elastomer having a crystalline structure is used in combination with the different elastomer, the proportion (weight proportion) of the olefin elastomer having a crystalline structure in the total of the olefin elastomer having a crystalline structure and the different elastomer is preferably 60% by weight or more. When the proportion is 60% by weight or more, it is easy to adjust the maximum value of loss tangent tan δ within the above range and adjust the degree of crystallinity within the above range, so that the impact-absorbing layer has improved impact resistance and improved resistance against sebum. The proportion is more preferably 70% by weight or more.

The different elastomer is not limited. Examples thereof include styrene elastomers, acrylic elastomers, urethane elastomers, ester elastomers, vinyl chloride elastomers, and amide elastomers. These elastomers may be used alone or in combination of two or more thereof.

Preferred among them are styrene elastomers from the standpoints of adjustment of the maximum value of loss tangent tan δ within the above range and adjustment of the degree of crystallinity within the above range.

The styrene elastomer may be any styrene elastomer having rubber elasticity at room temperature. The styrene elastomer more preferably has a diblock or triblock structure including a polystyrene layer called a hard segment and a soft segment such as ethylene-butylene, ethylene-propylene, or ethylene-butadiene.

Specific examples of the styrene elastomer include styrene-butadiene-styrene (SBS) block copolymer, styrene-butadiene-butylene-styrene (SBBS) block copolymer, styrene-ethylene-butylene-styrene (SEBS) block copolymer, hydrogenated styrene-butylene rubber (HSBR), styrene-ethylene-propylene-styrene (SEPS) block copolymer, styrene-isobutylene-styrene (SIBS) block copolymer, and styrene-isoprene-styrene (SIS) block copolymer. More preferred among them are SEBS and SEPS because they contain no double bond in the molecular structure and thus are comparatively stable against heat and light.

The styrene elastomer may have any styrene content. The lower limit thereof is preferably 3% by weight and the upper limit thereof is preferably 30% by weight. When the styrene content is 3% by weight or more, the impact-absorbing layer has improved heat resistance or improved cohesion force. When the styrene content is 30% by weight or less, the styrene elastomer has increased flexibility, leading to a high maximum value of loss tangent tan δ. The impact-absorbing layer thus has improved impact resistance. The lower limit of the styrene content is more preferably 4% by weight and the upper limit thereof is more preferably 25% by weight. The lower limit is still more preferably 5% by weight and the upper limit is still more preferably 20% by weight.

The amount of each block such as styrene in the styrene elastomer can be measured by ¹H-NMR (1H-nuclear magnetic resonance) or ¹³C-NMR analysis, for example.

The soft segment in the styrene elastomer may have any ethylene skeleton content. The upper limit thereof in 100% by weight of the entire soft segment is preferably 60% by weight. When the ethylene skeleton content is 60% by weight or less, the styrene elastomer has increased flexibility, leading to a high maximum value of loss tangent tan δ. The impact-absorbing layer thus has improved impact resistance. The upper limit of the ethylene skeleton content is more preferably 50% by weight, still more preferably 40% by weight.

Particularly in the case where the styrene elastomer is SEBS or HSBR, the ethylene skeleton content of the soft segment is preferably within the above range. In the case where the styrene elastomer is SEBS or HSBR, the ethylene skeleton content of the soft segment is preferably 3% by weight or more, more preferably 4% by weight or more, still more preferably 5% by weight or more. When the ethylene skeleton content is 3% by weight or more in the case where the styrene elastomer is SEBS or HSBR, the impact-absorbing layer has appropriate glass transition temperature, so that the maximum value of loss tangent tan δ can be easily adjusted within the above range. The butylene skeleton in SEBS has great steric hindrance and thus structurally easily inhibits crystallization, leading to a high tan δ value and easy impact absorption. Thus, in the case where the styrene elastomer is SEBS, the soft segment may have any butylene skeleton content, but preferably has a butylene skeleton content of 45% by weight or more. When the butylene skeleton content is 45% by weight or more, excellent impact resistance can be exhibited. The butylene skeleton content is more preferably 60% by weight or more, still more preferably 70% by weight or more.

SEPS is less prone to crystallization because more than two ethylene skeletons are never linked in sequence. In addition, the propylene skeleton has high bulkiness. SEPS thus leads to a high tan δ and easy impact absorption.

Similar to the ethylene skeleton, the 1,4-butadiene skeleton contained in the soft segment of the SBBS is also easily crystallized and thus may reduce flexibility. This may result in a reduction in the maximum value of the tan δ and the impact resistance. The total amount of ethylene and 1,4-butadiene in the soft segment of SBBS is thus preferably 60% by weight or less, more preferably 50% by weight or less, still more preferably 40% by weight or less.

The isobutylene skeleton contained in SIBS and the like is less likely to be crystallized. With SIBS or the like, thus, the tan δ can be controlled to be high. However, since the frequency of the peak value of the tan δ may fall out of the specified range, the ethylene skeleton may be preferably introduced to the soft segment to adjust the position of the tan δ peak.

The impact-absorbing layer may contain a tackifier resin. Adding a tackifier resin to the impact-absorbing layer makes it easy to adjust the maximum value of loss tangent tan δ within the above range.

Any tackifier resin may be used. Examples thereof include terpene resins, rosin resins, and petroleum resins.

The impact-absorbing layer may contain a softener. The impact-absorbing layer containing a softener has improved flexibility and improved impact resistance. Moreover, the impact-absorbing layer containing a softener improves the adhesiveness of the double-sided adhesive sheet of the present invention to an adherend when the impact-absorbing sheet of the present invention is used as the substrate of the double-sided adhesive sheet.

Any softener may be used. Examples thereof include petroleum softeners (paraffin oils), liquid rubber softeners, dibasic acid esters, plant softeners, and oil softeners. The difference in solubility parameter (SP value) between the softener and the resin constituting the impact-absorbing layer is preferably small. The SP value of the softener is preferably 9 or less. Use of such a softener can suppress delamination due to bleeding of the softener on the surface of the impact-absorbing layer while improving flexibility. Examples of the petroleum softener (paraffin oil) include Fukkol Flex 2050N (available from Fuji Kosan Company, Ltd.) and Diana Process Oil PW90 (available from Idemitsu Kosan Co., Ltd.). Examples of the liquid rubber softener include polybutene. The polybutene preferably has a number average molecular weight of 1,000 or more.

The softener content is not limited. The lower limit thereof based on 100 parts by weight of the resin constituting the impact-absorbing layer is preferably 50 parts by weight and the upper limit is preferably 250 parts by weight. When the softener content is 50 parts by weight or more, the impact-absorbing layer has improved flexibility. When the softener content is 250 parts by weight or less, the delamination due to bleeding of the softener can be suppressed. The lower limit of the softener content is more preferably 100 parts by weight and the upper limit thereof is more preferably 200 parts by weight.

The impact-absorbing layer may contain an antioxidant or ultraviolet absorber to improve weather resistance.

Any antioxidant or ultraviolet absorber may be used. Examples thereof include phenol, amine, or benzimidazole antioxidants or ultraviolet absorbers. Examples of the phenol antioxidant include NOCLAC NS-6 (available from Ouchi Shinko Chemical Industrial Co., Ltd.). Examples of the ultraviolet absorber include SEESORB 101 (available from Shipro Kasei Kaisha, Ltd.).

The impact-absorbing layer is preferably colored. The colored impact-absorbing layer can shield light from a liquid crystal display panel mounted in a portable electronic device.

Any colorant may be used. Colorants that can be used include pigments and dyes usually added to an adhesive sheet used for bonding and fixing a component of a portable electronic device to the device body. Examples of the colorant include carbon black such as furnace black, thermal black, acetylene black, channel black, lamp black, and Ketjenblack. The examples also include: oxides such as iron oxide, titanium oxide, zinc oxide, magnesium oxide, cobalt oxide, copper oxide, chromium oxide, and alumina; sulfates such as calcium sulfate, barium sulfate, iron sulfate, and mercury sulfate; and carbonates such as calcium carbonate, magnesium carbonate, and dolomite. The examples also include: metal powders such as iron powder, copper powder, tin powder, lead powder, and aluminum powder; organic pigments such as azo pigments, phthalocyanine pigments, and dioxazine pigments; and graphite. Preferred among them is carbon black.

The impact-absorbing layer may have any colorant content. The lower limit thereof is preferably 0.1% by weight and the upper limit thereof is preferably 10% by weight. The lower limit is more preferably 0.3% by weight and the upper limit is more preferably 5% by weight. Adding an excessive amount of the colorant may cause uneven coloration of the impact-absorbing layer due to poor dispersion of the colorant.

The lower limit of the OD value of the impact-absorbing layer is preferably 2 and the upper limit thereof is preferably 7. When the OD value is 2 or more, the impact-absorbing layer can sufficiently reduce light transmission both in the width direction and the thickness direction. When the OD value is 7 or less, the flexibility of the impact-absorbing layer is not impaired, and the impact resistance can be maintained. The lower limit of the OD value is more preferably 4 and the upper limit thereof is more preferably 6.

The OD value can be measured with a haze meter (e.g., NDH4000 available from Nippon Denshoku Industries Co., Ltd.).

The impact-absorbing layer may contain fine particles for purposes such as imparting heat resistance, rigidity, conductivity, or the like or reducing weight.

Any fine particles may be used. Examples thereof include ceramic fine particles made of silica, talc, mica, alumina, or the like, metal fine particles made of copper, nickel, cobalt, gold, or the like, plastic fine particles made of polyamide resin, acrylic resin, epoxy resin, ether sulfone resin, polyamideimide resin, or the like, and hollow fine particles made of silica or resin polymer.

The impact-absorbing layer may have a foam structure for purposes such as imparting flexibility. The foam structure may be formed by a method such as chemical foaming using a foaming agent, physical foaming by gas kneading or the like, or mixing of hollow fine particles. The impact-absorbing layer may have any thickness. The lower limit thereof is preferably 50 μm and the upper limit thereof is preferably 400 μm. The impact-absorbing layer having a thickness of 50 μm or more has sufficient strength and improved impact resistance. The impact-absorbing layer having a thickness of 400 μm or less can satisfy the recent needs for a thinner adhesive sheet. The upper limit of the thickness is more preferably 300 μm.

The proportion of the thickness of the impact-absorbing layer in the impact-absorbing sheet of the present invention is not limited. For the impact-absorbing sheet to have excellent impact resistance, the lower limit of the proportion is preferably 40%, more preferably 50%.

The impact-absorbing sheet of the present invention preferably further includes an outer layer integrally laminated on at least one surface of the impact-absorbing layer. The outer layer may be formed on only one surface of the impact-absorbing layer or on both surfaces of the impact-absorbing layer.

The outer layer can further suppress the entry and absorption of fat into the impact-absorbing layer and improve the resistance of the impact-absorbing sheet against sebum. The outer layer can also improve the punching processability and the handleability of the impact-absorbing sheet.

The outer layer preferably has a tensile modulus of elasticity of 200 MPa or more. When the tensile modulus of elasticity is 200 MPa or more, the impact-absorbing sheet is further improved in the resistance against sebum, the punching processability, and the handleability.

The upper limit of the tensile modulus of elasticity is not limited. Too high a tensile modulus of elasticity may lead to low flexibility of the outer layer and thus to low impact resistance of the laminate including the outer layer and the impact-absorbing layer. The upper limit is thus preferably 2,000 MPa, more preferably 1,800 MPa.

The tensile modulus of elasticity can be measured in accordance with the ASTM D638 method.

The outer layer and the impact-absorbing layer preferably have a difference in solubility parameter (SP value) of 2 or less. When the difference in SP value is 2 or less, the anchoring between the outer layer and the impact-absorbing layer is high, so that the entry and absorption of fat into the impact-absorbing layer can be further suppressed. The difference in SP value is more preferably 1 or less.

The outer layer may be constituted by any resin. Examples of the resin include polyolefins and thermoplastic elastomers. In particular, use of a polyolefin lead to good anchoring between the impact-absorbing layer and the outer layer and thus can reduce variation in impact resistance.

Examples of the polyolefin include high density polyethylene (HDPE), low density polyethylene (LDPE), linear low density polyethylene (LLDPE), and polypropylene (PP). Examples of the thermoplastic elastomer include polyamide (PA) and polybutylene terephthalate (PBT).

The impact-absorbing sheet of the present invention may further contain a different layer.

For example, laminating a conductive film on the impact-absorbing layer can impart conductivity to the impact-absorbing sheet. Applying a primer to the impact-absorbing layer can increase the adhesiveness between the impact-absorbing layer and the adhesive layer described later, or can impart various properties to the impact-absorbing layer.

The impact-absorbing sheet of the present invention preferably has a tensile modulus of elasticity of 150 MPa or more. The impact-absorbing sheet having a tensile modulus of elasticity of 150 MPa or more is further improved in the resistance against sebum, the punching processability, and the handleability. The lower limit of the tensile modulus of elasticity is more preferably 300 MPa, still more preferably 500 MPa.

The impact-absorbing sheet of the present invention may have any thickness. The lower limit thereof is preferably 60 μm and the upper limit thereof is preferably 1,000 μm. The impact-absorbing sheet having a thickness of 60 μm or more has sufficient strength and improved impact resistance. The impact-absorbing sheet having a thickness of 1,000 μm or less can satisfy the recent needs for a thinner adhesive layer. The upper limit of the thickness is more preferably 500 μm, still more preferably 200 μm.

The impact-absorbing sheet of the present invention may be produced by any method. In an exemplary method, the materials to constitute the impact-absorbing layer are fed to a melt extruder and extruded into a sheet form. In the case where the impact-absorbing sheet of the present invention contains the different layer in addition to the impact-absorbing layer, for example, the materials of the layers are co-extruded to form a multilayer sheet.

The impact-absorbing sheet of the present invention can be used in any application. The impact-absorbing sheet is preferably used as a substrate of an adhesive sheet for bonding and fixing a component of a portable electronic device to the device body, or as a substrate of an adhesive sheet for bonding and fixing an in-vehicle component. The portable electronic device is not limited to conventional rigid portable electronic devices, and may be a portable electronic device that can be exposed to severer conditions such as a wearable device or a bendable device.

The impact-absorbing sheet of the present invention in these applications may have any shape. Examples of the shape include a rectangular shape, a frame shape, a circular shape, an elliptic shape, and a doughnut shape.

The present invention also encompasses a double-sided adhesive sheet including the impact-absorbing sheet of the present invention and an adhesive layer integrally laminated on both surfaces of the impact-absorbing sheet of the present invention. The adhesive layers on both surfaces may have the same composition or different compositions.

In the double-sided adhesive sheet of the present invention, the impact-absorbing layer preferably has a 25% compressive strength of 930 kPa or less. When the 25% compressive strength is 930 kPa or less, the double-sided adhesive sheet has improved adhesiveness to an adherend. Specifically, when the double-sided adhesive sheet is attached to an adherend, it is possible to suppress a reduction in the attachability due to difficulty in removing the air between the adherend and the double-sided adhesive sheet. The upper limit of the 25% compressive strength is more preferably 800 kPa, still more preferably 600 kPa.

The 25% compressive strength of the impact-absorbing layer can be adjusted within the above range by controlling the composition of the impact-absorbing layer. For example, it is preferred to adjust the ratio of the block polymer to be used or add the softener. In particular, it is preferred that the impact-absorbing layer contains the softener.

The 25% compressive strength of the impact-absorbing layer can be measured as follows. First, the impact-absorbing layer as a measurement target is cut to pieces of 20 mm×20 mm. The pieces are laminated to a thickness of 6 mm to prepare a specimen. Next, the specimen is compressed by 25% of the thickness with a universal tester (e.g., autograph AGS-X available from Shimadzu Corp.) at a speed of 10 ram/min. The pressure needed for the compression is measured.

The adhesive layer is not limited. The adhesive layer preferably contains an acrylic adhesive.

Any acrylic adhesive may be used. The adhesive layer preferably contains a (meth)acrylate copolymer containing a constitutional unit derived from a fluorine-containing (meth)acrylate (hereinafter also referred to as a “fluorine-containing (meth)acrylate copolymer”.

The “(meth)acrylate” herein refers to acrylate or methacrylate.

The constitutional unit derived from a fluorine-containing (meth)acrylate can impart high resistance against sebum to the adhesive layer because fluorine itself has high water and oil repellency and the molecular chain thereof is less likely to allow entrance of sebum thereinto due to dense packing of fluorine atoms. Even when the acrylic adhesive contains a fluorine-containing (meth)acrylate copolymer, the tackiness of the adhesive layer can be maintained.

Examples of the fluorine-containing (meth)acrylate include 2,2,2-trifluoroethyl acrylate, 2-(perfluorohexyl)ethyl acrylate, 2,2,3,3,3-pentafluoropropyl acrylate, 2-(perfluorobutyl)ethyl acrylate, 3-perfluorobutyl-2-hydroxypropyl acrylate, 3-perfluorohexyl-2-hydroxypropyl acrylate, 3-(perfluoro-3-methylbutyl)-2-hydroxypropyl acrylate, 1H,1H,3H-tetrafluoropropyl acrylate, 1H,1H,5H-octafluoropentyl acrylate, 1H,1H,7H-dodecafluoroheptyl acrylate, 1H-1-(trifluoromethyl)trifluoroethyl acrylate, 1H,1H,3H-hexafluorobutyl acrylate, and 1,2,2,2-tetrafluoro-1-(trifluoromethyl)ethyl acrylate. Preferred among these is 2,2,2-trifluoroethyl acrylate because the resistance against sebum is especially high.

The lower limit of the amount of the constitutional unit derived from a fluorine-containing (meth)acrylate in the fluorine-containing (meth)acrylate copolymer is preferably 30% by weight and the upper limit thereof is preferably 80% by weight. With the amount of 30% by weight or more, the adhesive layer has improved resistance against sebum. With the amount of 80% by weight or less, the acrylic adhesive is not too hard, and has improved adhesive force. The lower limit of the amount is more preferably 40% by weight and the upper limit thereof is more preferably 60% by weight.

The fluorine-containing (meth)acrylate copolymer preferably further contains a constitutional unit derived from a (meth)acrylate having an alkyl group with a carbon number of 2 or less. The fluorine-containing (meth)acrylate copolymer containing a constitutional unit derived from a (meth)acrylate having an alkyl group with a carbon number of 2 or less can have further enhanced resistance against sebum.

Examples of the (meth)acrylate having an alkyl group with a carbon number of 2 or less include methyl (meth)acrylate and ethyl (meth)acrylate. Preferred among these is ethyl acrylate because the acrylic adhesive is not too hard and has improved adhesive force.

The amount of the constitutional unit derived from a (meth)acrylate having an alkyl group with a carbon number of 2 or less in the fluorine-containing (meth)acrylate copolymer is not limited. The lower limit of the amount is preferably 15% by weight and the upper limit thereof is preferably 40% by weight. With the amount falling within the above range, the adhesive layer can have further enhanced resistance against sebum. The lower limit of the amount is more preferably 20% by weight and the upper limit thereof is more preferably 30% by weight.

The fluorine-containing (meth)acrylate copolymer preferably further contains a constitutional unit derived from a monomer having a crosslinkable functional group.

When the fluorine-containing (meth)acrylate copolymer contains the constitutional unit derived from a monomer having a crosslinkable functional group, the use of a crosslinking agent in combination allows crosslinking between fluorine-containing (meth)acrylate copolymer chains. Adjustment of the degree of crosslinking at that time can adjust the gel fraction and the swelling ratio.

Examples of the crosslinkable functional group include hydroxy, carboxy, glycidyl, amino, amide, and nitrile groups. Preferred among these are hydroxy and carboxy groups because the gel fraction of the adhesive layer is easily adjusted. Examples of the monomer having a hydroxy group include (meth)acrylic acid esters having a hydroxy group such as 4-hydroxybutyl (meth)acrylate and 2-hydroxyethyl (meth)acrylate.

Examples of the monomer having a carboxy group include (meth)acrylic acid.

Examples of the monomer having a glycidyl group include glycidyl (meth)acrylate.

Examples of the monomer having an amide group include hydroxyethylacrylamide, isopropylacrylamide, and dimethylaminopropylacrylamide.

Examples of the monomer having a nitrile group include acrylonitrile. These monomers having a crosslinkable functional group may be used alone or in combination of two or more thereof.

The amount of the constitutional unit derived from a monomer having a crosslinkable functional group in the fluorine-containing (meth)acrylate copolymer is not limited.

The lower limit thereof is preferably 1% by weight and the upper limit thereof is preferably 5% by weight. With the amount falling within the above range, adjustment of the swelling ratio and the gel fraction is facilitated, so that the adhesive layer has improved resistance against sebum.

The fluorine-containing (meth)acrylate copolymer may further contain a constitutional unit derived from a different monomer as long as the effect of the present invention is not impaired. Examples of the different monomer include propyl acrylate, butyl acrylate, cyclohexyl acrylate, octyl acrylate, nonyl acrylate, isobornyl acrylate, benzyl acrylate, phenoxyethyl acrylate, and vinyl acetate.

The lower limit of the weight average molecular weight (Mw) of the fluorine-containing (meth)acrylate copolymer is preferably 500,000 and the upper limit thereof is preferably 2,000,000. With the weight average molecular weight within the range, the adhesive layer has improved adhesive force, so that the double-sided adhesive sheet has improved impact resistance. The lower limit of the weight average molecular weight is more preferably 600,000 and the upper limit thereof is more preferably 1,200,000. The weight average molecular weight (Mw) can be adjusted by adjusting the polymerization conditions (e.g., the type or amount of the polymerization initiator, the polymerization temperature, and the monomer concentration). The weight average molecular weight (Mw) is a weight average molecular weight in terms of standard polystyrene determined by gel permeation chromatography (GPC).

For synthesis of the fluorine-containing (meth)acrylate copolymer, an acrylic monomer from which the above constitutional unit is derived may be radically reacted in the presence of a polymerization initiator. The polymerization method is not particularly limited and a conventionally known method may be employed. Examples thereof include solution polymerization (boiling point polymerization or constant temperature polymerization), emulsion polymerization, suspension polymerization, and bulk polymerization. In particular, preferred is solution polymerization because the synthesis is easy.

In the case of employing solution polymerization as a polymerization method, examples of a reaction solvent include ethyl acetate, toluene, methyl ethyl ketone, methyl sulfoxide, ethanol, acetone, and diethyl ether. These reaction solvents may be used alone or in combination of two or more thereof.

Any polymerization initiator may be used. Examples thereof include organic peroxides and azo compounds. Examples of the organic peroxides include 1,1-bis(t-hexylperoxy)-3,3,5-trimethylcyclohexane, t-hexyl peroxypivalate, t-butyl peroxypivalate, 2,5-dimethyl-2,5-bis(2-ethylhexanoylperoxy)hexane, t-hexyl peroxy-2-ethylhexanoate, t-butyl peroxy-2-ethylhexanoate, t-butyl peroxyisobutyrate, t-butyl peroxy-3,5,5-trimethylhexanoate, and t-butyl peroxylaurate. Examples of the azo compounds include azobisisobutyronitrile and azobiscyclohexanecarbonitrile. These polymerization initiators may be used alone or in combination of two or more thereof.

The acrylic adhesive preferably contains a crosslinking agent. In the case where the fluorine-containing (meth)acrylate copolymer has the constitutional unit derived from a monomer having a crosslinkable functional group, addition of a crosslinking agent enables construction of a crosslinking structure.

Any crosslinking agent is may be used. Examples thereof include isocyanate crosslinking agents, aziridine crosslinking agents, epoxy crosslinking agents, and metal chelate crosslinking agents. Preferred among these are isocyanate crosslinking agents and epoxy crosslinking agents.

The amount of the crosslinking agent relative to 100 parts by weight of the fluorine-containing (meth)acrylate copolymer is preferably 0.01 to 10 parts by weight, more preferably 0.1 to 5 parts by weight.

The acrylic adhesive may contain a silane coupling agent. When the acrylic adhesive contains a silane coupling agent, the adhesive layer has improved adhesiveness to an adherend and thus has further improved resistance against sebum.

Any silane coupling agent may be used. Examples thereof include vinyltrimethoxysilane, vinyltriethoxysilane, γ-methacryloxypropyltrimethoxysilane, γ-methacryloxypropylmethyldimethoxysilane, γ-glycidoxypropyltrimethoxysilane, γ-glycidoxypropylmethyldimethoxysilane, γ-glycidoxypropylmethyldiethoxysilane, γ-glycidoxypropyltriethoxysilane, 2-(3,4-epoxycyclohexyl)ethyltrimethoxysilane, γ-aminopropyltrimethoxysilane, γ-aminopropyltriethoxysilane, γ-aminopropyltrimethylmethoxysilane, N-(2-aminoethyl)3-γaminopropyltriethoxysilane, N-(2-aminoethyl)3-aminopropylmethyldimethoxysilane, γ-mercaptopropyltrimethoxysilane, γ-mercaptopropyltriethoxysilane, mercaptobutyltrimethoxysilane, and γ-mercaptopropylmethyldimethoxysilane. Preferred among these is γ-glycidoxypropyltriethoxysilane.

The amount of the silane coupling agent is not limited. The lower limit of the amount of the silane coupling agent relative to 100 parts by weight of the acrylic adhesive is preferably 0.1 parts by weight and the upper limit thereof is preferably 5 parts by weight. With the amount of 0.1 parts by weight or more, the resistance against sebum can be further enhanced. With the amount of 5 parts by weight or less, adhesive deposits upon re-peeling can be suppressed. The lower limit of the amount is more preferably 1 part by weight and the upper limit thereof is more preferably 3 parts by weight.

The adhesive layer may optionally contain additives such as a plasticizer, an emulsifier, a softener, a filler, a pigment, and a dye, tackifiers such as a rosin resin and a terpene resin, and other resins.

The adhesive layer preferably has a gel fraction of 5% by weight or more. With the gel fraction of 5% by weight or more, the swelling ratio of the adhesive layer can be easily adjusted, leading to improved resistance against sebum. The lower limit of the gel fraction is more preferably 10% by weight. The upper limit of the gel fraction is not limited, and is preferably 95% by weight, more preferably 90% by weight.

The adhesive layer may have any thickness. The lower limit of the thickness of the adhesive layer is preferably 5 μm and the upper limit thereof is preferably 50 μm. With the thickness of the adhesive layer of 5 μm or more, the double-sided adhesive sheet has further enhanced adhesiveness. With the thickness of the adhesive layer of 50 μm or less, the double-sided adhesive sheet has further enhanced processability.

The double-sided adhesive sheet of the present invention preferably has a total thickness of 100 to 400 μm. The double-sided adhesive sheet having a total thickness of 100 μm or more has improved impact resistance. The double-sided adhesive sheet having a total thickness of 400 μm or less is suitable for the application of bonding and fixing a component of a portable electronic device to the device body.

The double-sided adhesive sheet of the present invention may have any compressive strength. The lower limit of the 25% compressive strength is preferably 10 kPa and the upper limit thereof is preferably 2,000 kPa. When the 25% compressive strength is 10 kPa or more, it is possible to suppress protrusion of the impact-absorbing sheet as a substrate sideways when the double-sided adhesive sheet is pressure-bonded to an adherend. When the 25% compressive strength is 2,000 kPa or less, it is possible to suppress a reduction in the attachability due to difficulty in removing the air between the adherend and the double-sided adhesive sheet. The lower limit of the 25% compressive strength is more preferably 30 kPa and the upper limit thereof is more preferably 1,000 kPa.

The double-sided adhesive sheet of the present invention may be produced by the following method, for example.

First, a solvent is added to a fluorine-containing (meth)acrylate copolymer and, if needed, a crosslinking agent and the like, thereby preparing a solution of an acrylic adhesive a. The solution of an acrylic adhesive a is applied to the surface of the impact-absorbing sheet as a substrate, and the solvent in the solution is completely dried to be removed. Thus, an adhesive layer a is formed. Next, a release film is placed on the adhesive layer a in such a manner that the release-treated surface of the release film faces the adhesive layer a.

Then, another release film is provided and to the release-treated surface of the release film is applied a solution of an acrylic adhesive b. A solvent in the solution is completely dried to be removed. Thus, a laminated film including a release film and an adhesive layer b formed on the surface of the release film is produced. The obtained laminated film is placed on the rear surface (surface without the adhesive layer) of the impact-absorbing sheet in such a manner that the adhesive layer b faces the rear surface of the substrate. Thus, a laminate is produced. The laminate is pressurized using a rubber roller or the like to provide a double-sided adhesive sheet including an adhesive layer on each surface of the impact-absorbing sheet, in which the surface of each adhesive layer is covered with a release film.

In another method, two laminated films are produced in the same manner. The laminated films are placed on both surfaces of the impact-absorbing sheet as a substrate in such a manner that the adhesive layer of each laminated film faces the impact-absorbing sheet, thereby preparing a laminate. The laminate is pressurized using a rubber roller or the like to provide a double-sided adhesive tape including an adhesive layer on each surface of the impact-absorbing sheet, in which the surface of each adhesive layer is covered with a release film.

The double-sided adhesive sheet of the present invention may be used in any application. The double-sided adhesive sheet is preferably used in applications such as bonding and fixing a component of a portable electronic device to the device body or bonding and fixing an in-vehicle component. Specifically, the double-sided adhesive sheet of the present invention can be used as a double-sided adhesive sheet for bonding and fixing a liquid crystal display panel of a portable electronic device to the device body. The portable electronic device is not limited to conventional rigid portable electronic devices, and may be a portable electronic device that can be exposed to severer conditions such as a wearable device or a bendable device.

The double-sided adhesive sheet of the present invention in these applications may have any shape. Examples of the shape include a rectangular shape, a frame shape, a circular shape, an elliptic shape, and a doughnut shape.

In particular, when the double-sided adhesive sheet of the present invention has a frame shape and is used as an adhesive sheet for fixing a front plate, an adhesive sheet for fixing a back plate, or an adhesive sheet for fixing a backlight unit in a portable electronic device, breaking of the portable electronic device can be effectively prevented even when impact of a drop or the like is applied. Even when the width of the frame-shaped adhesive sheet becomes smaller (for example, a width of 1.0 mm or lower) with the recent increase in the size of the screen of portable electronic devices, the adhesive sheet can exhibit high impact resistance.

### Advantageous Effects of Invention

The present invention can provide an impact-absorbing sheet having high impact resistance and excellent resistance against sebum. The present invention can also provide a double-sided adhesive sheet including the impact-absorbing sheet.

### BRIEF DESCRIPTION OF DRAWINGS

FIG. 1 is a schematic view illustrating a drop impact test of double-sided adhesive sheets obtained in examples and comparative examples.

### DESCRIPTION OF EMBODIMENTS

The present invention is more specifically described in the following with reference to, but not limited to, examples.

### EXAMPLE 1

### (1) Preparation of Impact-Absorbing Sheet

An amount of 100 parts by weight of an olefin crystal-ethylene-butylene-olefin crystal (CEBC) block polymer (DYNARON 6200 available from JSR Corporation) and 3 parts by weight of carbon black were used as materials to constitute an impact-absorbing layer. Low density polyethylene (LDPE) (PE in Table 1) was used as a material to constitute outer layers.

The materials to constitute an impact-absorbing layer and the material to constitute outer layers were melted at 200° C. These molten resins were laminated in a multilayer die while being extruded (co-extruding temperature: 200° C.) The extrudate was then cooled to give an impact-absorbing sheet in which an outer layer having a thickness of 10 μm was laminated on each side of a non-foam impact-absorbing layer having a thickness of 60 μm.

The impact-absorbing layer was cut to 5 mm×30 mm and chucked at the longitudinal sides (30 mm sides) at a chuck gap of 15 mm in a dynamic viscoelasticity measuring apparatus (Rheogel-E4000 available from UBM). The tensile viscoelastic modulus was measured within the range of −60° C. to 100° C. at a temperature increase rate of 5° C./min, and a master curve was established at a reference temperature of 23° C. to calculate the maximum value of loss tangent tan δ at a frequency of 1.0×10³ to 1.0×10^{6.5} Hz at 23° C. The frequency at which the local maximum of the loss tangent tan δ occurred was also determined.

Separately, the impact-absorbing layer was cut to 30 mm×30 mm. The impact-absorbing layer was irradiated with X-rays using an X-ray diffraction device (SmartLab available from Rigaku Corp.). In the obtained diffraction data (diffraction profile), a scattering region derived from an amorphous portion and a scattering region derived from a crystalline portion were separated. The degree of crystallinity was calculated as the ratio of the integrated crystalline scattering intensity to the total integrated scattering intensity.

The transmittance was also measured with a haze meter (NDH4000 available from Nippon Denshoku Industries Co., Ltd.) and the OD value of the impact-absorbing layer was calculated.

The SP values of the impact-absorbing layer and the outer layers were calculated based on the constitutional units of the polymers constituting the impact-absorbing layer and the outer layers and the Fedor's equation.

The tensile moduli of elasticity of the outer layers and the impact-absorbing sheet were calculated according to the ASTM D638 method.

### (2) Preparation of Adhesive A

A reaction vessel was charged with ethyl acetate as a polymerization solvent and the ethyl acetate was bubbled with nitrogen. The reaction vessel was heated while nitrogen was flowed thereinto, thereby starting reflux. Subsequently, to the reaction vessel was added a polymerization initiator solution prepared by diluting 0.1 parts by weight of azobisisobutyronitrile, as a polymerization initiator, 10 times with ethyl acetate. Then, 63.5 parts by weight of butyl acrylate, 33.5 parts by weight of 2,2,2-trifluoroethyl acrylate, and 3 parts by weight of acrylic acid were dropwise added over two hours. After the dropwise addition, the polymerization initiator solution prepared by diluting 0.1 parts by weight of azobisisobutyronitrile, as a polymerization initiator, 10 times with ethyl acetate was again added to the reaction vessel, and the polymerization reaction was allowed to proceed for four hours. Thus, a (meth)acrylate copolymer-containing solution was obtained.

To the obtained (meth)acrylate copolymer-containing solution was added TETRAD-C (available from Mitsubishi Gas Chemical Company), as a crosslinking agent, in an amount of 1 part by weight relative to 100 parts by weight of the (meth)acrylate copolymer. Thus, an adhesive A was obtained.

### (3) Production of Double-Sided Adhesive Sheet

The adhesive A was applied with an applicator to a 75-μm-thick release PET film release-treated with silicon. The adhesive A was dried at 110° C. for three minutes to form an adhesive layer having a thickness of 35 μm. This adhesive layer was bonded to the impact-absorbing sheet using a silicon roller to give a one-side adhesive sheet. Both surfaces of the impact-absorbing sheet were corona-treated in advance with a corona treatment device (“CT-0212” available from Kasuga Denki, Inc.) under the conditions of 270 W and 18 m/min.

In the same manner, the release PET film on the opposite surface of the impact-absorbing sheet was removed, and the same adhesive layer as above was bonded to the surface. The adhesive layers were then aged at 40° C. for 48 hours. Thus, a double-sided adhesive sheet in which each surface was covered with a release PET film was obtained.

### (EXAMPLE 2

A double-sided adhesive sheet was obtained as in Example 1 except that the CEBC block polymer and a styrene-ethylene-propylene-styrene (SEPS) block copolymer (SEPTON 2063 available from Kuraray Co., Ltd.) were used (CEBC:SEPS ratio=8:2) in the impact-absorbing layer instead of the CEBC block polymer alone.

### EXAMPLE 3

A double-sided adhesive sheet was obtained as in Example 2 except that the CEBC:SEPS ratio was 6:4.

### EXAMPLE 4

A double-sided adhesive sheet was obtained as in Example 2 except that the CEBC:SEPS ratio was 4:6.

### EXAMPLE 5

A double-sided adhesive sheet was obtained as in

Example 1 except that polypropylene (PP) was used in the outer layers.

### EXAMPLE 6

A double-sided adhesive sheet was obtained as in Example 1 except that the amount of carbon black was changed to 1 part by weight relative to 100 parts by weight of the block polymer so as to adjust the OD value to 2.5.

### EXAMPLE 7

A double-sided adhesive sheet was obtained as in Example 1 except that the amount of carbon black was changed to 6 parts by weight relative to 100 parts by weight of the block polymer so as to adjust the OD value to 6.6.

### EXAMPLE 8

A double-sided adhesive sheet was obtained as in Example 1 except that in the preparation of the adhesive, the monomers added dropwise were changed to 23.5 parts by weight of butyl acrylate, 23.5 parts by weight of ethyl acrylate, 50 parts by weight of 2,2,2-trifluoroethyl acrylate, and 3 parts by weight of acrylic acid to give an adhesive B.

### EXAMPLE 9

A double-sided adhesive sheet was obtained as in Example 2 except that the adhesive B was used instead of the adhesive A.

### EXAMPLE 10

A double-sided adhesive sheet was obtained as in Example 1 except that a single layer was melt-extruded using only the materials to constitute the impact-absorbing layer, and that no outer layer was formed.

### EXAMPLE 11

A double-sided adhesive sheet was obtained as in Example 1 except that a softener (polybutene, number average molecular weight: 1,350) was added (70 parts by weight relative to 30 parts by weight of CEBC) to the impact-absorbing layer.

### EXAMPLE 12

A double-sided adhesive sheet was obtained as in Example 11 except that the amount of the softener added was changed (50 parts by weight to 50 parts by weight of CEBC).

### EXAMPLE 13

A double-sided adhesive sheet was obtained as in Example 12 except that the softener was changed to a petroleum softener (paraffin oil) (Diana Process Oil PW90, available from Idemitsu Kosan Co., Ltd.).

### COMPARATIVE EXAMPLE 1

A double-sided adhesive sheet was obtained as in Example 1 except that a styrene-ethylene-propylene-styrene (SEPS) block copolymer was used in the impact-absorbing layer instead of the CEBC block polymer (CEBC:SEPS ratio=0:10).

### COMPARATIVE EXAMPLE 2

A double-sided adhesive sheet was obtained as in Example 2 except that the CEBC:SEPS ratio was 2:8.

### COMPARATIVE EXAMPLE 3

A double-sided adhesive sheet was obtained as in Example 1 except that a polyethylene terephthalate (PET) film (E5100 available from Toyobo Co., Ltd., thickness: 75 μm) was used as the impact-absorbing sheet.

### <Evaluation>

The following evaluations were performed on the double-sided adhesive sheets obtained in the examples and the comparative examples. Table 1 shows the results.

### (1) Drop Impact Test

### <Preparation of Test Device>

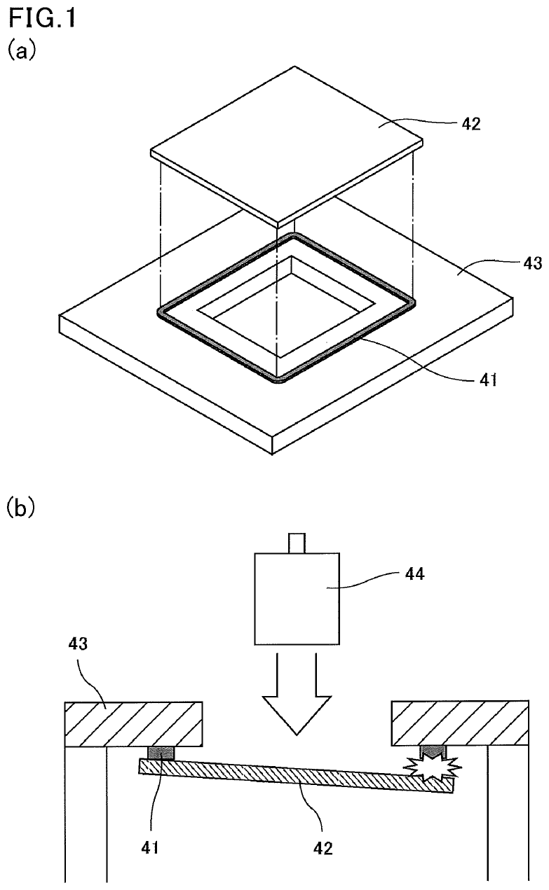

FIG. 1 is a schematic view illustrating a drop impact test of the double-sided adhesive sheets obtained in the examples and the comparative examples. A piece having outer dimensions of 46 mm wide and 61 mm long and inner dimensions of 44 mm wide and 59 mm long was punched out of the obtained double-sided adhesive sheet to prepare a frame-shaped specimen having a width of 1 mm. Next, as shown in FIG. 1(a), the specimen 41, with the release paper removed, was attached to a 2-mm-thick polycarbonate plate 43 having a square opening of 38 mm wide and 50 mm long in its center portion. The specimen 41 was attached such that the square opening was positioned substantially at the center. A polycarbonate plate 42 of 55 mm wide, 65 mm long, and 1 mm thick was then attached from above the specimen 41 such that the specimen 41 was positioned substantially at the center. A test device was thus assembled. A pressure of 5 kgf was then applied for 10 seconds from the side of the upper polycarbonate plate of the test device, whereby the upper and lower polycarbonate plates and the specimen were pressure-bonded. The workpiece was left to stand at room temperature for 24 hours.

### <Evaluation on Drop Impact Resistance>

As shown in FIG. 1(b), the test device prepared above was turned upside down and fixed to a support. An iron ball 44 of a size that can pass through the square opening and a weight of 300 g was dropped through the square opening. The height from which the iron ball was dropped was gradually increased so as to measure the iron ball drop height at which the specimen was peeled off from the polycarbonate plate due to the impact of the iron ball drop.

A rating “oo (Excellent)” was given when the height was 70 cm or higher. A rating “o (Good)” was given when the height was 50 cm or higher and lower than 70 cm. A rating “x (Poor)” was given when the height was lower than 50 cm.

### (2) Evaluation on Resistance Against Sebum (Measurement of Oleic Acid Swelling Ratio)

A plane rectangular test piece (20 mm×40 mm) was cut out from each of the impact-absorbing layers obtained in the examples and the comparative example before the lamination of the outer layers. The weight of the test piece was measured. The test piece was immersed in oleic acid under the conditions of a temperature of 40° C. and a humidity of 90% for 24 hours, and taken out from the oleic acid. The surface of the test piece was washed with ethanol. Then, the test piece was dried at 70° C. for three hours. The weight of the dried test piece was measured, and the oleic acid swelling ratio of the impact-absorbing layer was calculated using the following equation (1):

Swelling ratio (% by weight)=100×(W₅)/(W₄) (1)

(W₄: weight of test piece before immersion in oleic acid, W₅: weight of test piece after immersion in oleic acid and drying).

An impact-absorbing layer having an oleic acid swelling ratio of preferably 100 to 300% by weight, more preferably 100 to 200% by weight can be determined to exhibit high resistance against oleic acid, a main component of sebum. In Table 1, a rating “o (Good)” was given when the oleic acid swelling ratio was 100% by weight or more and a rating “x (Poor)” was given when the impact-absorbing layer was dissolved due to the immersion (oleic acid swelling ratio was lower than 100% by weight).

### (3) Evaluation on Processability (Punching Evaluation)

Each of the double-sided adhesive sheets obtained in the examples and the comparative examples, together with the release paper, was cut in the thickness direction by moving the cutter of a cutting machine upward and downward, whereby a frame-shaped piece was punched out. The presence or absence of partial detachment of the adhesive layers from the release paper and wrinkles were visually determined.

A rating “o (Good)” was given when neither the partial detachment of the adhesive layers from the release paper nor wrinkles were observed. A rating of “Δ (Fair)” was given when partial detachment or wrinkles were observed but the frame shape obtained by punching was maintained. A rating “x (Poor)” was given when the frame shape obtained by punching was not maintained due to partial detachment or wrinkles.

### (4) Evaluation on Adhesiveness (Evaluation of Adhesive Area)

One side of each of the double-sided adhesive sheets obtained in the examples and the comparative examples was attached to a glass plate having a thickness of 2 mm in such a manner that the double-sided adhesive sheet and the glass plate were completely bonded (adhesive area was 100%). Next, an acrylic plate having a thickness of 3 mm was provided. The other side of the double-sided adhesive sheet was pressure-bonded to the acrylic plate by reciprocating a 10-kg roller once. An image of the specimen was captured from the acrylic plate side with a digital camera (1920×1080 pixels, a magnification of 4 times). The obtained image was binarized into a black and white image (the threshold was ½ of the maximum concentration). The proportion of the area of the black portion to the area of the entire double-sided adhesive sheet was calculated as the adhesive area proportion.

TABLE 1

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Impact- | Degree of crystallinity | | 6 | 5 | 4 | 2 | 6 | 6 | 6 | 6 |
| absorbing | (X-ray diffraction) (%) | | | | | | | | | |
| layer | Loss | Maximum | 0.90 | 1.06 | 1.38 | 1.55 | 0.90 | 0.90 | 0.90 | 0.90 |
| | tangent | value at 1.0 × 10³ to | | | | | | | | |
| | tanδ | 1.0 × 10^{6.5} Hz | | | | | | | | |
| | | Frequency of | 5.70 | 5.67 | 5.62 | 5.55 | 5.70 | 5.70 | 5.70 | 5.70 |
| | | local | | | | | | | | |
| | | maximum | | | | | | | | |
| | | log (freq. (Hz)) | | | | | | | | |

| | CEBC:SEPS ratio | 10:0 | 8:2 | 6:4 | 4:6 | 10:0 | 10:0 | 10:0 | 10:0 |
|---|---|---|---|---|---|---|---|---|---|
| | CEBC:softener weight ratio | — | — | — | — | — | — | — | — |
| | OD value | 4.9 | 4.9 | 4.9 | 4.9 | 4.9 | 2.5 | 6.6 | 4.9 |
| | SP value (cal/cm³)^{1/2} | 8.27 | 8.4 | 8.52 | 8.65 | 8.27 | 8.27 | 8.27 | 8.27 |
| | 25% compressive strength (kPa) | 1000 | 930 | 850 | 770 | 1000 | 1000 | 1000 | 1000 |
| Outer | Material | PE | PE | PE | PE | PP | PE | PE | PE |
| layer | Tensile modulus of elasticity | 200 | 200 | 200 | 200 | 1600 | 200 | 200 | 200 |
| | (D638 method) (MPa) | | | | | | | | |
| | SP value | 8.56 | 8.56 | 8.56 | 8.56 | 8.02 | 8.56 | 8.56 | 8.56 |
| Impact- | Tensile modulus of elasticity | 180 | 180 | 180 | 170 | 1350 | 180 | 180 | 180 |
| absorbing | (D638 method) (MPa) | | | | | | | | |
| sheet | | | | | | | | | |
| Adhesive layer | | A | A | A | A | A | A | A | B |
| Impact | Drop impact test results (cm) | 50 | 55 | 63 | 70 | 50 | 50 | 50 | 53 |
| resistance | Evaluation | ∘ | ∘ | ∘ | ∘∘ | ∘ | ∘ | ∘ | ∘ |
| Resistance | Swelling ratio (% by weight) | 120 | 161 | 193 | 236 | 120 | 120 | 120 | 120 |
| against | 40° C./90% RH | | | | | | | | |
| sebum | Evaluation | ∘ | ∘ | ∘ | ∘ | ∘ | ∘ | ∘ | ∘ |
| Process- | Punching evaluation | ∘ | ∘ | ∘ | ∘ | ∘ | ∘ | ∘ | ∘ |
| ability | | | | | | | | | |
| Adhesive- | Adhesive area ratio (%) | 73 | 80 | 82 | 87 | 69 | 75 | 76 | 78 |
| ness | | | | | | | | | |

| | | | | | | | | Compar- | Compar- | Compar- |
|---|---|---|---|---|---|---|---|---|---|---|
| | | | Example | Example | Example | Example | Example | ative | ative | ative |
| | | | 9 | 10 | 11 | 12 | 13 | Example 1 | Example 2 | Example 3 |
| Impact- | Degree of crystallinity | | 5 | 6 | 5 | 5 | 5 | 0 | 1 | 35 |
| absorbing | (X-ray diffraction) (%) | | | | | | | | | |
| layer | Loss | Maximum | 1.06 | 0.90 | 0.98 | 1.12 | 1.12 | 2.07 | 1.72 | 0.09 |
| | tangent | value at 1.0 × 10³ to | | | | | | | | |
| | tanδ | 1.0 × 10^{6.5} Hz | | | | | | | | |
| | | Frequency of | 5.67 | 5.70 | 5.12 | 4.31 | 4.31 | 5.50 | 5.52 | — |
| | | local | | | | | | | | |
| | | maximum | | | | | | | | |
| | | log (freq. (Hz)) | | | | | | | | |

| | CEBC:SEPS ratio | 8:2 | 10:0 | 10:0 | 10:0 | 10:0 | 0:10 | 2:8 | — |
|---|---|---|---|---|---|---|---|---|---|
| | CEBC:softener weight ratio | — | — | 3:7 | 5:5 | 5:5 | — | — | — |
| | OD value | 4.9 | 4.9 | 4.9 | 4.9 | 4.9 | 4.9 | 4.9 | — |
| | SP value (cal/cm³)^{1/2} | 8.4 | 8.27 | 7.36 | 7.59 | 7.59 | 8.9 | 8.78 | 13.17 |
| | 25% compressive strength (kPa) | 930 | 1000 | 900 | 410 | 410 | 450 | 650 | <1000 |
| Outer | Material | PE | — | PE | PE | PE | PE | PE | — |
| layer | Tensile modulus of elasticity | 200 | — | 200 | 200 | 200 | 200 | 200 | — |
| | (D638 method) (MPa) | | | | | | | | |
| | SP value | 8.56 | — | 8.56 | 8.56 | 8.56 | 8.56 | 8.56 | — |
| Impact- | Tensile modulus of elasticity | 180 | 120 | 180 | 160 | 160 | 170 | 170 | 3600 |
| absorbing | (D638 method) (MPa) | | | | | | | | |
| sheet | | | | | | | | | |
| Adhesive layer | | B | A | A | A | A | A | A | A |
| Impact | Drop impact test results (cm) | 58 | 77 | 65 | 75 | 50 | 90 | 73 | 10 |
| resistance | Evaluation | ∘ | ∘∘ | ∘ | ∘∘ | ∘ | ∘∘ | ∘∘ | x |
| Resistance | Swelling ratio (% by weight) | 161 | 120 | 102 | 115 | 115 | (Dis- | (Dis- | 103 |
| against | 40° C./90% RH | | | | | | solved) | solved) | |
| sebum | Evaluation | ∘ | ∘ | ∘ | ∘ | ∘ | x | x | ∘ |
| Process- | Punching evaluation | ∘ | Δ | ∘ | ∘ | ∘ | ∘ | ∘ | ∘ |
| ability | | | | | | | | | |
| Adhesive- | Adhesive area ratio (%) | 82 | 88 | 85 | 92 | 95 | 92 | 88 | 67 |
| ness | | | | | | | | | |

### INDUSTRIAL APPLICABILITY

The present invention can provide an impact-absorbing sheet having high impact resistance and excellent resistance against sebum. The present invention can also provide a double-sided adhesive sheet including the impact-absorbing sheet.

### REFERENCE SIGNS LIST

41 specimen (frame shape)
42 polycarbonate plate (thickness: 1 mm)
43 polycarbonate plate (thickness: 2 mm)
44 iron ball (300 g)

1. An impact-absorbing sheet comprising
an impact-absorbing layer,
the impact-absorbing layer having a maximum value of loss tangent tan δ of 0.7 or more at a frequency of 1.0×10³ to 1.0×10^{6.5} Hz at 23° C. and having a degree of crystallinity of 2% or higher.

2. The impact-absorbing sheet according to claim 1,
wherein the impact-absorbing layer contains an olefin elastomer having a crystalline structure.

3. The impact-absorbing sheet according to claim 1,
wherein the impact-absorbing layer has an OD value of 7 or less.

4. The impact-absorbing sheet according to claim 1,
further comprising an outer layer integrally laminated on at least one surface of the impact-absorbing layer,
wherein the outer layer has a tensile modulus of elasticity of 200 MPa or more.

5. The impact-absorbing sheet according to claim 4,
wherein the outer layer and the impact-absorbing layer have a difference in solubility parameter (SP value) of 2 or less.

6. A double-sided adhesive sheet comprising:
the impact-absorbing sheet according to claim 1; and
an adhesive layer integrally laminated on both surfaces of the impact-absorbing sheet.

7. The double-sided adhesive sheet according to claim 6, wherein the impact-absorbing layer has a 25% compressive strength of 930 kPa or less.

8. The double-sided adhesive sheet according to claim 6, which is used for bonding and fixing a component of a portable electronic device to a device body.
